(19) United States
(12) Patent Application Publication
(10) Pub. No.: US 2026/0316086 A1
(43) Pub. Date: Oct. 15, 2026

(54) CAGE ASSEMBLY FOR CAGE MILL CRUSHING MACHINES

(71) Applicant: TerraSource Global Corporation, St. Louis, MO (US)

(72) Inventors: Derrick James Jansen, O'Fallon, IL (US); Michael Rai Anderson, Sugar Land, TX (US); Patrick Welch, St. Louis, MO (US)

(73) Assignee: TerraSource Global Corporation, St. Louis, MO (US)

(21) Appl. No.: 19/426,843

(22) Filed: Dec. 19, 2025

Related U.S. Application Data
(60) Provisional application No. 63/736,240, filed on Dec. 19, 2024.

(51) Int. Cl. B02C 13/28; B02C 13/282

(52) U.S. Cl. CPC B02C 13/2804; B02C 13/282

(57) ABSTRACT

A cage mill assembly includes cage rings and striking bars interconnected by wedge-shaped mechanical connections. Each connection includes wedge-shaped connection members on the cage ring and striking bar that taper such that a radially outward end is narrower than a radially inward end. During rotation, centrifugal force urges the striking bar radially outward, driving the wedge-shaped connection members into progressively tighter engagement as rotational speed increases. This creates a mechanical locking force that increases with rotational speed and retains the striking bar even if fasteners fail. The striking bars are individually replaceable.

### CROSS-REFERENCE TO RELATED APPLICATIONS

The present application claims priority to U.S. Provisional Application 63/736,240, titled Cage Assembly for Cage Mill Crushing Machines and filed on Dec. 19, 2024. The disclosure of the above application is incorporated herein by reference in its entirety.

### FIELD

This disclosure relates generally to material size reduction of ores or aggregates. More particularly, the present invention relates to cage mill crushing machines.

### BACKGROUND

Cage mills are a common type of crusher used throughout the industrial sector for size reduction of raw materials. A cage assembly is the main component of a cage mill performing the crushing/sizing of the material though a series of impacts. The cage assembly consists of a series of impact surfaces (commonly referred to as striking plates, pins, or bars) mounted in a series of concentric rings, typically called “rows.” The cage rings are attached to a plate which is turned by a shaft assembly.

These machines are offered in a variety of sizes to handle various capacities of feed material. Cage mills are also offered in a single rotating cage and dual rotating cage assemblies. The single rotating cage has an inner and outer rotating row which impacts material against a stationary row between the two rotating rings. Dual rotating cages are spun by two counter-rotating shafts which impact material against each row (no stationary row). The impact force of dual rotating cages often can size material finer than the single rotating cage counterpart.

Most cage mill assemblies have a fully welded construction that does not allow for replaceable parts. These cage types are only able to be repaired through expensive and time-consuming re-application of hardfacing or weld-wire which can build up worn away areas of lost material but requires disassembly of the entire cage structure. Other cage mill assemblies may have some replaceable components such as replaceable striking plates, pins, or bars. However, these cage mill assemblies still rely on shear bolt strength for absorbing impact. This means that when bolt strength fails the striking bar may be thrown from the cage.

The welded structure of conventional cages also introduces heat affected zones with high carbon concentrations. Cage mills tend to operate at speeds anywhere from 300-1000 RPM and thus generate a significant amount of airflow similar to a box fan. Salts, potassium, potash, lithium and other materials commonly crushed in cage mills are mixed with large amounts of water before being inserted into the machine. The resulting brine solution combined with the high air velocities accelerates the fatiguing of the welded joints, especially at heat affected zones, through metal absorption of hydrogen atoms in a process called “hydrogen embrittlement.” Hydrogen embrittlement causes metal to become less ductile and more brittle which can result in unpredictable cracking and fracturing, even at stresses below the metal's original yield strength.

Thus, there exists a need for a cage mill assembly that allows for easily replaceable parts without requiring disassembly of the entire cage structure, does not rely on shear bolt strength for absorbing impact, and avoids a welded structure and the associated hydrogen embrittlement.

### SUMMARY

A striking bar for a cage mill cage assembly is disclosed, the striking bar comprising a first end, a second end, and a center section located between the first and second ends, the center section having a striking face. At least one of the first end, the second end, or a cross-section of the striking bar including the striking face can have a wedge shape. If the first end has a wedge shape, the cross section and the second end can have any shape known in the art, including wedge shapes. If the second end has a wedge shape, the first end and the cross section can have any shape known in the art, including wedge shapes. If the cross section has a wedge shape, the first and the second end can have any shape known in the art, including wedge shapes. The first end and the second end can each have a wedge shape while the cross section has any shape known in the art, including wedge shapes. The first end, the second end, and the cross section can all simultaneously have a wedge shape.

Further, a cage ring for a mill cage assembly comprising a recess formed in an inner surface configured to receive an end portion of a striking bar of the cage assembly, wherein the recess has a first end positioned radially inwardly on the ring and a second end positioned radially outwardly on the ring, and wherein a width of the second end is smaller than a width of the first end, is disclosed.

A cage assembly for a cage mill comprising a striking bar comprising a first end, a second end, and a center section located between the first and second ends and having striking face, wherein at least one of the first or second ends has a wedge shape; and a cage ring comprising a recess formed on an inner surface with a first end positioned radially inwardly on the ring and a second end positioned radially outwardly on the ring, wherein a width of the second end is smaller than a width of the first end and wherein the recess is configured to receive an end portion of the striking bar of the cage assembly, is additionally disclosed.

Likewise, a cage assembly for a cage mill comprising a striking bar comprising a first end, a second end, center section having a striking face between the first end and the second end, wherein a cross section of the striking bar that includes the striking face is wedge shaped; and a cage ring comprising a recess formed on an inner surface with a first end positioned radially inwardly on the ring and a second end positioned radially outwardly on the ring, wherein a width of the second end is smaller than a width of the first end and wherein the recess is configured to receive an end portion of the striking bar of the cage assembly, is disclosed.

Moreover, a method of replacing a striking bar in a cage ring of a cage mill assembly comprising removing at least one bolt and lock-washer from a cage assembly cage mill cage ring, sliding a striking bar inward toward ring center, sliding a replacement striking bar into a recess formed in an inner surface of the cage ring of the cage mill assembly, and attaching a bolt and a lock-washer to the cage ring and the striking bar, is disclosed.

Finally, a method of replacing a striking bar in a cage ring of a cage mill assembly comprising removing at least one bolt and lock-washer from a cage assembly cage mill cage ring comprising a recess formed in an inner surface configured to receive an end portion of a striking bar of the cage assembly, wherein the recess has a first end positioned radially inwardly on the ring and a second end positioned radially outwardly on the ring, and wherein a width of the second end is smaller than a width of the first end; sliding a striking bar comprising a first end and a second end, wherein at least one of the first or second ends have a wedge shape inward toward ring center; sliding a replacement striking bar comprising a first end, a second end, a center section located between the first and second ends and having striking face, wherein at least one of the first or second ends have a wedge shape into the recess formed in an inner surface of the cage ring of the cage mill assembly configured to receive an end portion of a striking bar of the cage assembly, wherein the recess has a first end positioned radially inwardly on the ring and a second end positioned radially outwardly on the ring, and wherein a width of the second end is smaller than a width of the first end; and attaching a bolt and a lock-washer to the cage ring and the striking bar, is disclosed.

### NOTES ON CONSTRUCTION

The use of the terms “a”, “an”, “the” and similar terms in the context of describing the invention are to be construed to cover both the singular and the plural, unless otherwise indicated herein or clearly contradicted by context. The terms “comprising”, “having”, “including” and “containing” are to be construed as open-ended terms (i.e., meaning “including, but not limited to,”) unless otherwise noted. The terms “substantially”, “generally” and other words of degree are relative modifiers intended to indicate permissible variation from the characteristic so modified. The use of such terms in describing a physical or functional characteristic of the invention is not intended to limit such characteristic to the absolute value which the term modifies, but rather to provide an approximation of the value of such physical or functional characteristics.

Terms concerning attachments, coupling and the like, such as “connected” and “interconnected”, refer to a relationship wherein structures are secured or attached to one another either directly or indirectly through intervening structures, as well as both moveable and rigid attachments or relationships, unless specified herein or clearly indicated by context. The term “operatively connected” is such an attachment, coupling or connection that allows the pertinent structures to operate as intended by virtue of that relationship.

The use of any and all examples or exemplary language (e.g., “such as” and “preferably”) herein is intended merely to better illuminate the invention and the preferred embodiment thereof, and not to place a limitation on the scope of the invention. Nothing in the specification should be construed as indicating any element as essential to the practice of the invention unless so stated with specificity.

As used in this description, the term “wedge” means a polygonal shape having a pair of non-parallel sides that taper inwardly toward one another and including at least one other side connecting those inwardly-tapering sides, where the “other side” may itself be formed by one or more interconnected sections. As an example, a rhombus or diamond shape is a wedge having one end formed by a pair of inwardly tapering sides that are joined together at a single point. Those inwardly tapering sides are connected by a third side that is, itself, formed by a pair of inwardly tapering and interconnected sections. The term wedge includes quadrilateral shapes having a pair of inwardly tapering sides including triangular shapes, trapezoidal shapes, kite shapes, and diamond shapes. In another example, in the case of a trapezoidal shape, the inwardly tapering sides are connected together by a pair of parallel lines.

### BRIEF DESCRIPTION OF THE DRAWINGS

Further advantages of the invention are apparent by reference to the detailed description when considered in conjunction with the figures, which are not to scale to more clearly show the details, wherein like reference numerals represent like elements throughout the several views, and wherein:

FIG. 1 is perspective view of a conventional dual shaft rotating cage mill and a material flowing through the cage mill;

FIG. 2 illustrates a conventional process of impaction of material between a plurality of adjacent and counter-rotating striking bar rows of cages in a rotating cage mill machine;

FIG. 3 is an exploded view of a row sub-assembly having striking bars according to an embodiment of the present disclosure;

FIG. 4 is a perspective view showing machining detail of an end of a striking bar according to an embodiment of the present disclosure;

FIG. 5 is an elevation view illustrating a wedge shape of a striking face of a striking bar according to an embodiment of the present disclosure;

FIG. 6 is a geometrical representation of the striking face and an angle formed therein;

FIG. 7 is a perspective view showing machining detail of a recess formed in an inner surface of a cage mill configured to receive an end portion of a striking bar of the cage assembly according to an embodiment of the present disclosure;

FIG. 8 is perspective view illustrating a bolted joint connection between a striking bar and a cage ring according to an embodiment of the present disclosure;

FIG. 9 is a cross sectional view of a bolted joint connection between a striking bar and a cage ring according to an embodiment of the present disclosure;

FIG. 10 is an exploded view of a large cage assembly according to an embodiment of the present disclosure;

FIG. 11 is an exploded view of a small cage assembly according to an embodiment of the present disclosure;

FIG. 12 is a perspective view of large and small cage assemblies according to an embodiment of the present disclosure;

FIG. 13 is a perspective view illustrating a step of a replacement process for an individual striking bar in a cage assembly according to an embodiment of the present disclosure; and

FIG. 14 is a detailed view depicting a striking bar being inserted into a top portion of the cage shown in FIG. 13.

### DETAILED DESCRIPTION

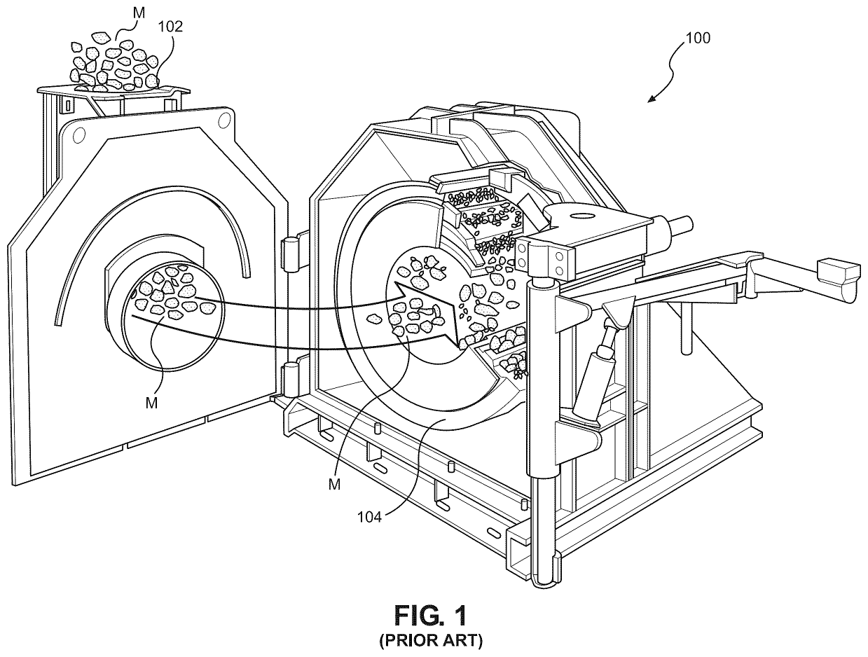

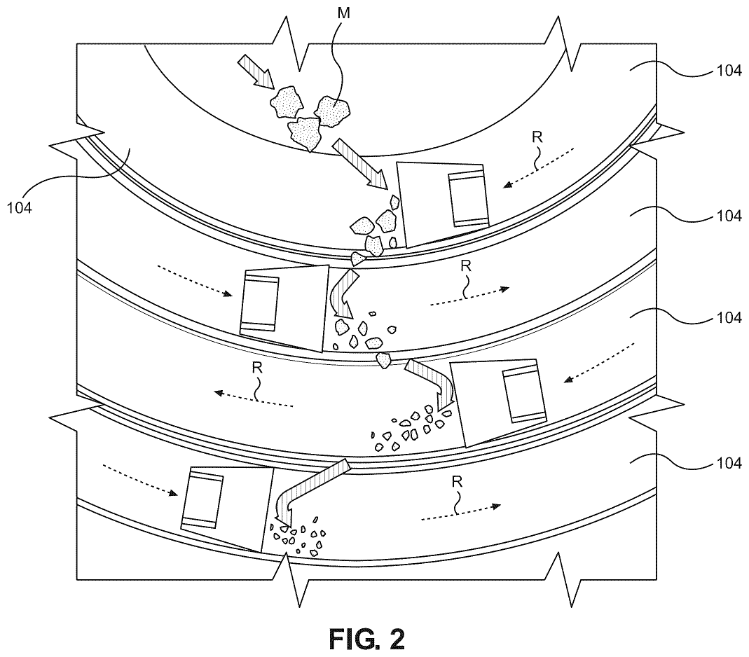

A conventional cage mill 100 is shown in FIG. 1. Material M enters through feed entrance 102 and flows into cage 104, where the material is then reduced in size. In particular, as shown in FIG. 2, material M passes through a plurality of counter-rotating cages 104, which reduces the size as the material. As the material M gains velocity due to rotation (e.g., clockwise) of cages 104 and the material decreases in size, the material moves sequentially into a second cage that preferably rotates in an opposing direction (e.g., counterclockwise) relative to the direction of rotation of the preceding cage. As the material M travels into successive cages 104, each preferably rotating in opposing direction, the material is progressively reduced in size until achieving a desired size.

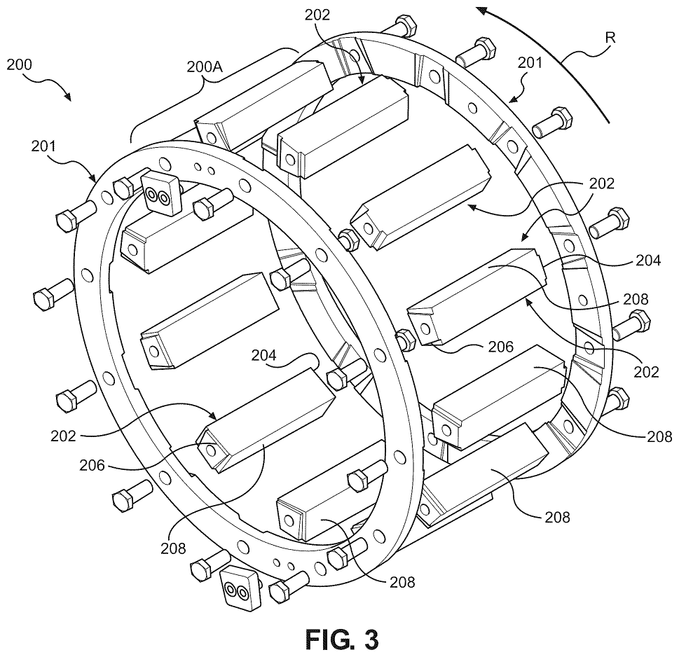

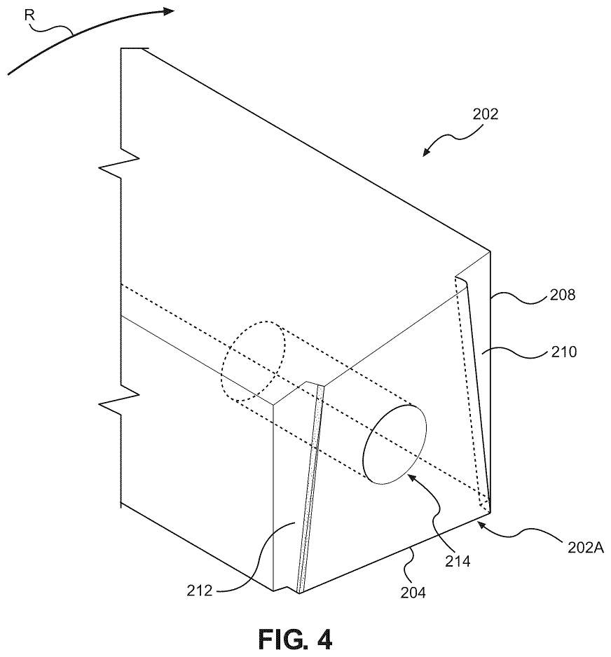

Referring to FIG. 3 and FIG. 4, a cage 200 having a spaced apart pair of parallel cage rings 201 to provide a space 200A between the cage rings is shown. The cage rings 201 are connected together by a plurality of striking bars 202 that extend across space 200A. Each of the striking bars 202 include a first end 204, second end 206, and a center section located between the first and second ends and having striking face 208. When mounted in a cage mill (not shown), cage 200 is configured to rotate in rotational direction R. As cage 200 rotates in rotational direction R, striking face 208 is configured to and contacts material (not shown) being processed in the cage assembly. Through such contact with the material, the striking face 208 reduces the size of the material. For each striking bar 202, the first end 204, second end 206, and/or a portion thereof, including an end lug 202A, preferably has a wedge shape. Additionally, a cross section of the striking bar 202 between the first end 204 and second end 206 may have a wedge shape. If the first end 204 of the striking bar 202 (or a corresponding end lug 202A of first end) has a wedge shape, the second end 206, other end lug, or cross section of the striking bar may have any shape known in the art, including a wedge shape. If second end 206 of the striking bar 202 (or a corresponding end lug 202A of second end) has a wedge shape, the first end 204, other end lug, or cross section of the striking bar may have any shape known in the art, including a wedge shape. More generally, in accordance with various embodiments of the present invention, any combination of first end 204, second end 206, end lugs 202A, and cross section of the striking bar 202 may have a wedge shape or any shape known in the art, provided at least one such surface is wedge in shape. Striking bar 202 may also comprise first contact region 210 and second contact region 212 (shown in FIG. 4) that are preferably located adjacent either side of end lug 202A at either or both the first end 204 and second end 206. Contact region 210 and contact region 212 may give first end 204, second end 206, or both first end 204 and second end 206 a protruding boss shape, as seen in FIG. 4, to define end lug 202A. Striking bar 202 may further comprise tapped hole 214 for a mounting bolt or other similar fasteners or fastener means.

The wedge-shaped connection between the striking bar 202 and cage ring 201 comprises a first wedge-shaped connection member and a second wedge-shaped connection member that are configured to engage one another. These connection members can be configured in alternative orientations.

In a first configuration, as shown in FIGS. 3-4 and 7-9, the first wedge-shaped connection member comprises a wedge-shaped end lug 202A that projects from the first end 204 and/or second end 206 of the striking bar 202, and the second wedge-shaped connection member comprises a correspondingly wedge-shaped recess 222 formed in the inward-facing surface 201A of the cage ring 201. In this first configuration, the end lug 202A on the striking bar 202 inserts into and engages the recess 222 on the cage ring 201.

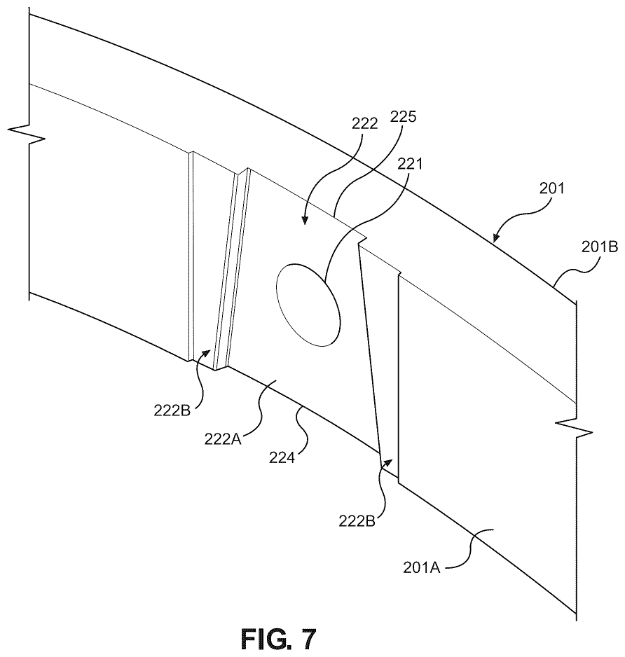

In a second configuration (not shown but understood by reversing the first configuration discussed above), the first wedge-shaped connection member comprises a wedge-shaped lug that projects inwardly from the inward-facing surface 201A of the cage ring 201, and the second wedge-shaped connection member comprises a correspondingly wedge-shaped recess formed in the first end 204 and/or second end 206 of the striking bar 202. In this second configuration, the lug on the cage ring 201 inserts into and engages the recess on the striking bar 202. The lug projecting from the cage ring in the second configuration has the same wedge-shaped geometry as the end lug 202A shown in FIGS. 3-4, and the recess formed in the striking bar in the second configuration has the same wedge-shaped geometry as the recess 222 shown in FIGS. 7-9, but with the positions reversed.

In both configurations, the wedge shape is oriented such that the narrower portion of the wedge is positioned radially outward relative to the wider portion. This orientation ensures that when the cage ring 201 rotates and generates centrifugal force acting on the striking bar 202, the centrifugal force urges the striking bar radially outward, which drives the first wedge-shaped connection member and the second wedge-shaped connection member into progressively tighter engagement with one another. As rotational speed increases, the centrifugal force increases, and the wedge-shaped connection members lock together more tightly. This progressive engagement provides mechanical retention that prevents the striking bar from being ejected from the cage ring even if the fastener 230 fails.

For clarity in the following description, when referring to the alternative second configuration, the wedge-shaped lug projecting from the cage ring may be referred to as “cage ring lug 201C” and the wedge-shaped recess formed in the striking bar may be referred to as “striking bar recess 202D,” although these components are not separately illustrated in the drawings. These components have the same geometric characteristics as the illustrated end lug 202A and recess 222, respectively, but with their positions on the cage ring and striking bar reversed.

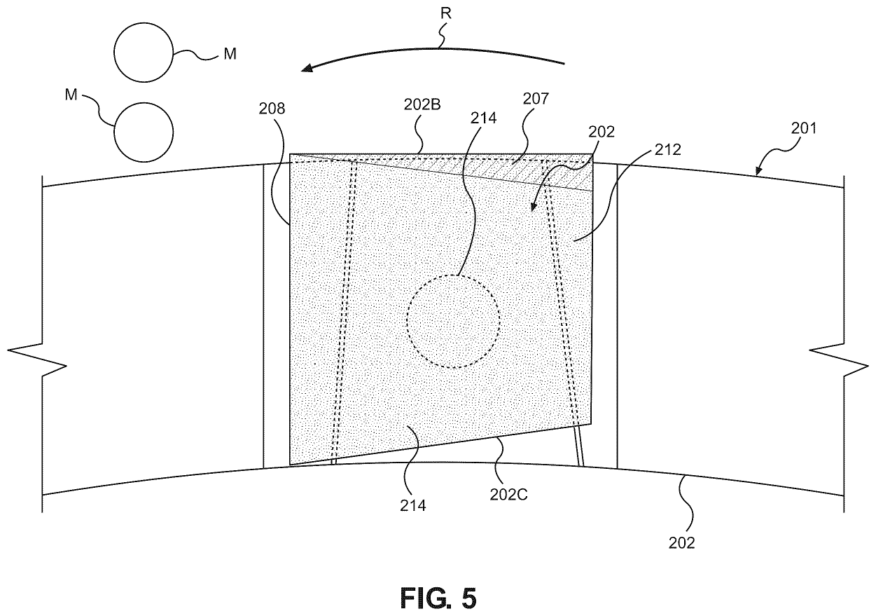

Prior art striking faces 208 of striking bars 202 are either rectangular, square, or circular when viewed from the striking face or front view. Rectangular or square striking faces are flat and crush more effectively than rounded surfaces. Circular surfaces, however, create less drag and use less power. With reference to FIG. 5, a portion of a cage ring 201 and striking bar 202 that each form part of a cage (not shown) that is configured to rotate in direction R according to an embodiment of the present disclosure is shown. A cross section of the center section of the striking bar 202, including striking face 208, can be wedge shaped including a trapezoidal shape. Hatched section 207 shows the area not present in the disclosed cross section that would be present in the prior art. The wedge-shaped cross-section of striking bar 202, including striking face 208, reduces drag and reduces power use while still providing a flat (i.e., planar) surface, via the striking face, that increases crushing ability. The top or radially-outward surface 202B and bottom or radially-inward surface 202C of striking bar 202 may taper inwardly at the same (i.e., equal) angle or at different angles, measured relative to striking face 208.

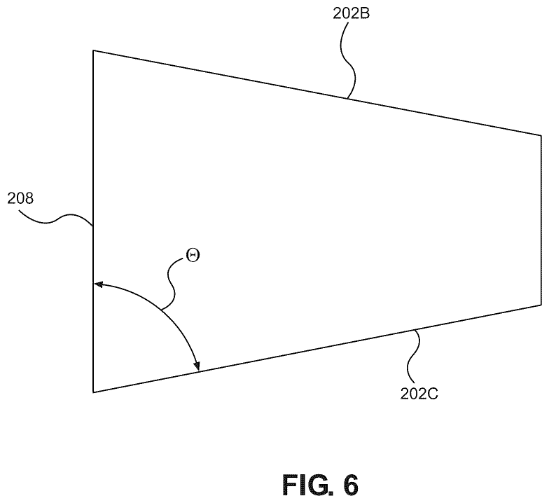

In certain embodiments, the top surface 202B and bottom surface 202C of bar 202 taper inwardly at an angle measured relative to striking face 208. More particularly, as is shown in FIG. 6, the top or radially-outward surface 202B and the bottom or radially-inward surface 202C of striking bar 202 form angle Θ. In FIG. 6, this angle Θ is shown only with respect to bottom surface 202C and striking face 208. However, the same or a different angle Θ can be provided between top surface 202B and striking face 208. In preferred embodiments, angle Θ ranges from 70° to some angle less than 90°. In some embodiments, angle Θ is greater than or equal to 80°. In certain embodiments, angle Θ ranges from 80° to 85°.

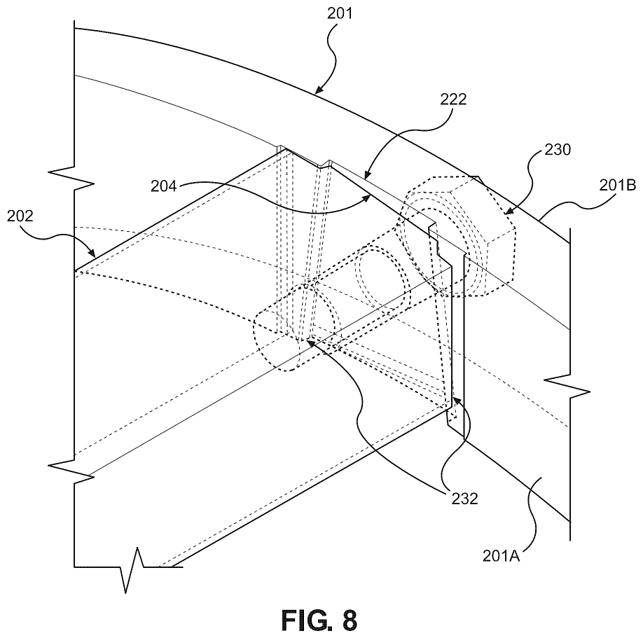

Referring to FIG. 7 and FIG. 8, a portion of a cage ring 201 for a cage mill according to an embodiment of the present disclosure is shown. As shown, cage ring 201 provides an inward-facing surface 201A and an opposing outward-facing surface 201B. The cage ring 201 includes a surface (which in the illustrated embodiment is the inward-facing surface 201A) that provides a wedge-shaped connection member configured to engage a correspondingly-shaped wedge-shaped connection member on a striking bar. As used here, the term “inward-facing,” when referring to cage rings 201, means in a direction toward towards the space 200A (FIG. 3) between the parallel cage rings 201 in cage 200. Conversely, “outward-facing,” when referring to cage rings 201, means in a direction away from the space 200A (FIG. 3) between the parallel cage rings 201 in cage 200. As discussed further below, in preferred embodiments, the cage ring 201 is provided with a first connection half and the striking bar 202 is provided with a second connection half that is sized and configured to engage the first connection half to removably connect the cage ring together with the striking bar. For example, in the illustrated embodiment, the cage ring 201 includes a fastener opening 221 and the striking bar 202 provides tapped hole 214 that corresponds to and aligns with the fastener opening when the cage ring is attached to the striking bar. When fastener opening 221 is aligned with tapped hole 214, a threaded fastener 230 (shown in FIG. 8) (e.g., bolt, bolt and lock washer, etc.) may be inserted through the fastener opening 221 and then threaded into tapped hole 214 to connect the cage ring 201 to striking bar 202.

The cage ring 201 includes a surface (which in the illustrated embodiment is the inward-facing surface 201A) that provides a wedge-shaped connection member. In the first configuration shown in the figures, this wedge-shaped connection member comprises a recess 222 formed in the inward-facing surface 201A. In the alternative second configuration (not shown), this wedge-shaped connection member would comprise a lug (such as cage ring lug 201C) projecting from the inward-facing surface 201A. The following description of recess 222 applies equally to the alternative configuration, with the understanding that what is described as a recess in the cage ring would be a lug in the alternative configuration, and vice versa. The recess 222 (or lug 201C in the alternative configuration) has a first end 224 positioned radially inwardly on the cage ring 201 and a second end 225 positioned radially outwardly on the cage ring 201.

Preferably, a width of an opening formed at the second end 225 of the recess 222 is smaller than an opening formed at the first end 224 of the recess. When the cage ring 201 rotates, the centrifugal force generated by such rotation urges the striking bar 202 radially outwards. Advantageously, the smaller width of the second end 225 prevents or limits radially outwards movement of the striking bar 202. Thus, even if the fastener 230 connecting the cage ring 201 to the striking bar 202 fails, the striking bar remains seated within the recess 222. When the cage ring 201 rotates, centrifugal force acts on the striking bar 202 in a radially outward direction. Because the wedge-shaped mechanical connection tapers such that the radially outward end (i.e., the second end 225) is narrower than the radially inward end (i.e., the first end 224), the centrifugal force drives the wedge-shaped members together more tightly. The mechanical locking force increases proportionally with rotational speed. This progressive engagement during rotation provides mechanical retention that secures the striking bar to the cage ring even if fastener 230 fails. In preferred embodiments, center section 222A of the recess 222 formed in (or provided on) the inward-facing surface 201A of the cage ring 201 has a wedge shape that corresponds to the wedge shape of the end lug 202A of the cage ring striking bar 202. In addition to the wedge-shaped center section 222A, the recess 222 may also include secondary machining surfaces 222B located on left and right sides of the center section (as seen in FIG. 7).

Secondary machining surfaces 222B may have a rectangular cross-section with sides substantially perpendicular to the inward-facing surface 201A. Secondary machining surfaces 222B provide a beginning datum point for the depth of recess 222 regardless of irregularities or tolerances in plate stock. This ensures consistent depth and positioning for each recess 222 across all striking bar positions around the cage ring 201, allowing for even clamping force distribution. In a cage ring 201 with a plurality of recesses 222, this datum point ensures each recess maintains solid contact with every striking bar in every position around the cage ring so that an even clamp load is applied consistently around the cage ring.

Secondary machining surface 222B also acts as a barrier that prevents entry of crushed material into recess 222 by creating a labyrinth seal effect between the striking bar end lug 202A and the recess 222. This barrier prevents (or substantially reduces) wear on the internal surfaces of recess 222 and maintains the integrity of the wedge-shaped connection during operation of cage 200. This prevents (or reduces) wear on the recess 222 when the cage 200 is in use.

The primary load-bearing contact during operation occurs between the wedge-shaped center section 222A of recess 222 and the wedge-shaped end lug 202A of striking bar 202. Secondary machining surface 222B is preferably configured as a positioning and sealing surface rather than a primary load-bearing surface. This design prevents the secondary machining surface 222B from creating gaps in the connection between the cage ring 201 and the striking bar 202, which could pre-load and fatigue the connector 230 during installation and use. In preferred embodiments, recess 222 and first end 204 or second end 206 of the striking bar 202 are sized and configured to provide zero net clearance, including between the contact regions 210, 212 of striking bar and secondary machining surfaces 222B of recess 222, thereby providing surface-to-surface contact between the cage ring 201 and striking bar 202. This surface-to-surface contact provides strong and substantial support that better withstands the force caused by material impact on the striking bar.

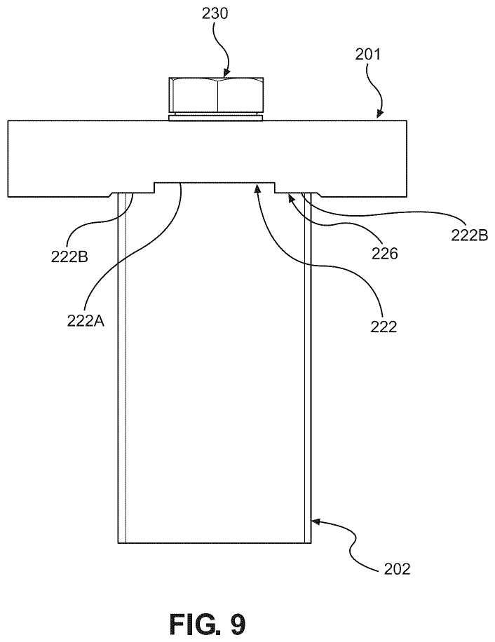

In FIG. 9, a selectively removable connection (i.e., capable of being connected and disconnected at a user's choice), such as a bolted connection, formed between a cage ring 201 and a striking bar 202 is shown. This bolted connection secures the wedge-shaped mechanical connection between the cage ring 201 and striking bar 202. In this case, connector 230 comprises a fastener connecting the striking bar to the cage ring and takes the form of a bolt and lock-washer. However, in other cases, the connector 230 may take other forms known to those of skill in the art. Bolts 230 can be hex head bolts or flat head bolts, although hex head bolts generally offer greater strength. In other cases, flat head bolts can be countersunk, though tolerance buildup between differing components present when countersunk bolts are used can make alignment of the removable striking bars to the countersunk cage structure difficult. The lock-washer can be wedged and two-piece, which prevents the bolts from loosening due to vibration.

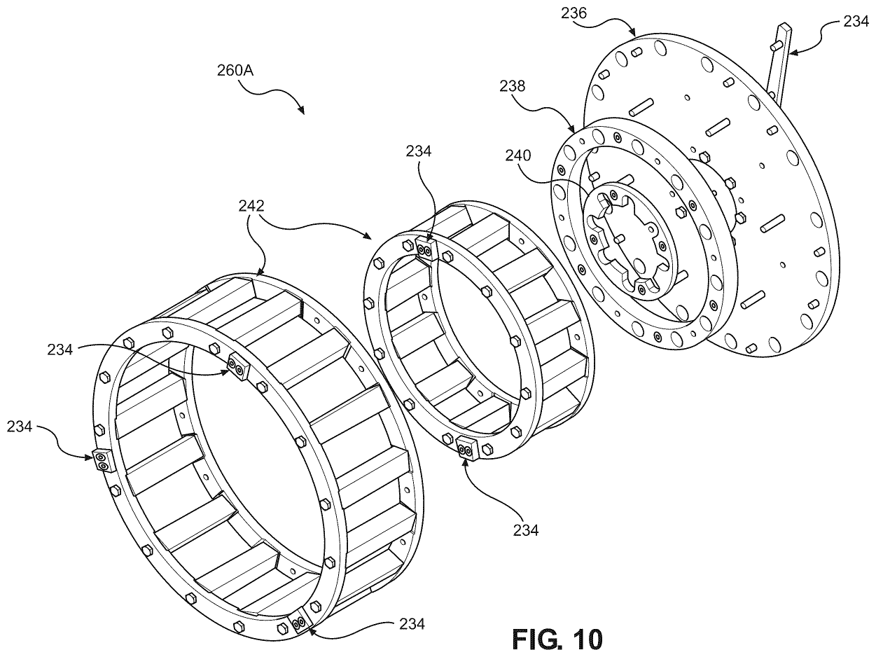

Referring now to FIG. 10, a large cage assembly 260A according to an embodiment of the present disclosure is shown. In the illustrated embodiment, one or more scraper plates 234 are mounted to the cage rings 201 in positions that shield the connectors 230 (e.g., bolt heads) from direct impact by material being processed. Each scraper plate 234 is positioned adjacent to and upstream (relative to the direction of cage rotation) of the connectors 230, creating a protective barrier that deflects incoming material away from the bolt heads and prevents or reduces wear on the connectors. The scraper plates 234 can be attached to either cage ring 201 using bolts, welding, or other suitable fastening methods known in the art. FIG. 10 also shows large cage main disc 236, which forms the central mounting structure for the cage assembly and provides attachment points for the cage rings 201; row spacer 238, which maintains proper alignment and spacing between adjacent rows of striking bars and helps align the centers of the striking bars from row to row; mounting hole cover plate 240, which covers the central mounting hole in main disc 236; and cage sub-assemblies 242, each comprising a pair of cage rings 201 with striking bars 202 mounted therebetween, suitable for a large cage of a cage mill.

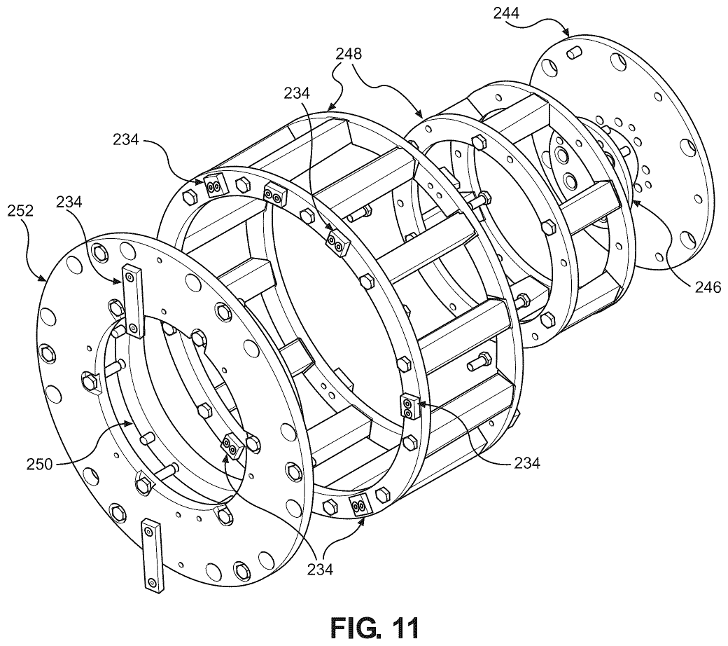

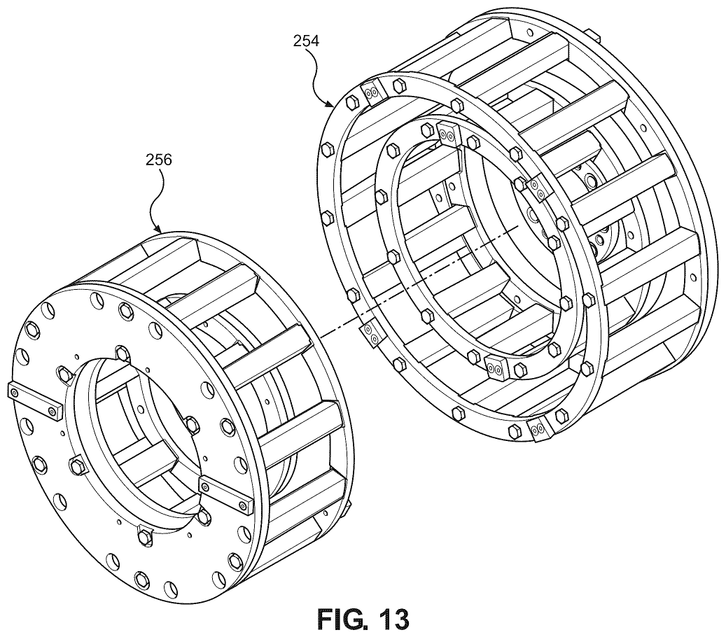

FIG. 11 shows a small cage assembly 254 and a small cage assembly 256 according to embodiments of the present disclosure. Similar to the large cage assembly 254, small cage assembly 256 includes scraper plates 234 for protecting connectors; small cage main disc 244, which is dimensionally adapted for smaller capacity applications; mounting hole cover plate 246; cage sub-assemblies 248, each comprising a pair of cage rings 201 with striking bars 202 mounted therebetween; spacer 250, which maintains proper axial spacing between components; and secondary mounting disc 252, which provides additional structural support and attachment points. The components of small cage assembly 256 are assembled by aligning the mounting holes in the various components (main disc 244, spacers 250, secondary mounting disc 252, and cover plate 246) and securing them together using bolts or other suitable fasteners. The cage sub-assemblies 248 are then mounted to the main disc 244 to form the complete small cage assembly 256 shown in FIG. 13.

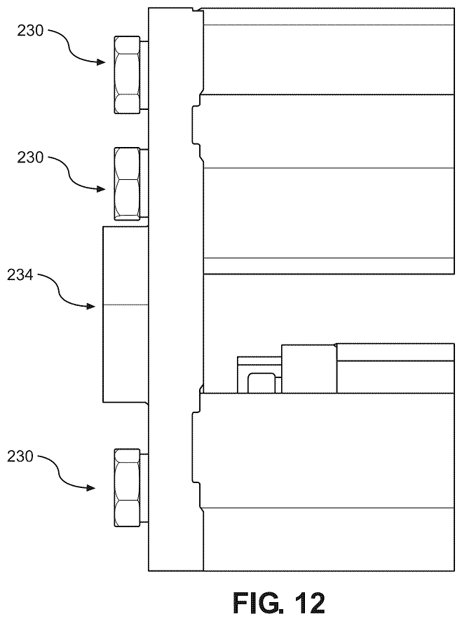

As shown in FIG. 12, the scrapers may be plates bolted to the ring that protrude higher than the bolts and washers. Typically, 2-4 scrapers are placed on each cage ring, and they are evenly spaced for balance.

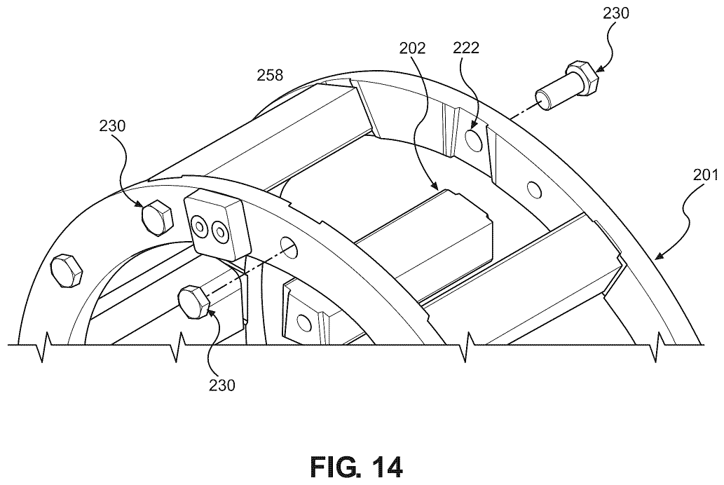

One of the key advantages of the disclosed striking bar and striking ring is the ability to replace individual striking bars. This allows for reduced cost of ownership and improved efficiency in operations. As can be seen in FIG. 14, connector 230 can be removed to allow striking bar 202 to slide toward ring center and thus removed. Then, a replacement striking bar, which can consist of any of the striking bars described above, can be inserted into recess 222 and affixed using connector 230. To remove striking bar 202, it may be necessary to loosen connectors 230 that are used to mount adjacent striking bars to cage ring 201.

What is claimed is:

1. A cage assembly for a cage mill, the cage assembly comprising:
a cage ring configured to rotate about an axis; and
a striking bar mounted to the cage ring and configured to rotate with the cage ring,
wherein the cage ring and the striking bar together provide a wedge-shaped mechanical connection comprising:
a first wedge-shaped connection member provided on one of the cage ring or the striking bar; and
a second wedge-shaped connection member provided on the other of the cage ring or the striking bar,
wherein the first wedge-shaped connection member and the second wedge-shaped connection member are configured to engage one another,
wherein each wedge-shaped connection member tapers from a radially inward end having a first width to a radially outward end having a second width, wherein the second width is smaller than the first width, and
wherein, during rotation of the cage ring, centrifugal force acting on the striking bar urges the striking bar radially outward and thereby drives the first wedge-shaped connection member and the second wedge-shaped connection member into progressively tighter engagement with one another as rotational speed increases, thereby mechanically locking the striking bar to the cage ring with a locking force that increases with rotational speed.

2. The cage assembly of claim 1, wherein the first wedge-shaped connection member comprises a wedge-shaped lug projecting from an end of the striking bar, and wherein the second wedge-shaped connection member comprises a correspondingly wedge-shaped recess formed in a surface of the cage ring configured to receive the wedge-shaped lug.

3. The cage assembly of claim 1, wherein the first wedge-shaped connection member comprises a wedge-shaped lug projecting from a surface of the cage ring, and wherein the second wedge-shaped connection member comprises a correspondingly wedge-shaped recess formed in an end of the striking bar configured to receive the wedge-shaped lug.

4. The cage assembly of claim 1, wherein the wedge-shaped mechanical connection is configured to retain the striking bar on the cage ring even if a fastener connecting the striking bar to the cage ring fails.

5. The cage assembly of claim 1, further comprising a fastener connecting the striking bar to the cage ring.

6. The cage assembly of claim 5, further comprising a scraper plate attached to the cage ring and positioned to shield the fastener from direct impact by material being processed.

7. The cage assembly of claim 1, wherein the striking bar comprises:
a first end and a second end;
a center section located between the first end and the second end, the center section having a striking face configured to contact material processed by the cage assembly,
wherein the wedge-shaped mechanical connection is provided at the first end, the second end, or both.

8. The cage assembly of claim 7, wherein a cross-section of at least a portion of the center section, including the striking face, is wedge-shaped.

9. The cage assembly of claim 8, wherein an angle formed between the striking face and at least one of a top surface or a bottom surface of the striking bar is greater than or equal to 80°.

10. The cage assembly of claim 8, wherein an angle formed between the striking face and at least one of a top surface or a bottom surface of the striking bar is between 80° and 85°.

11. A striking bar for a cage mill assembly, the striking bar comprising:
a first end;
a second end;
a center section located between the first end and the second end, the center section having a striking face configured to contact material processed by the cage mill assembly,
wherein at least one of the first end or the second end provides a wedge-shaped connection member configured to engage a correspondingly-shaped wedge-shaped connection member on a cage ring,
wherein the wedge-shaped connection member tapers from a radially inward portion having a first width to a radially outward portion having a second width when the striking bar is mounted to the cage ring, wherein the second width is smaller than the first width,
wherein the wedge-shaped connection member is configured such that, during rotation of the cage ring, centrifugal force acting on the striking bar drives the wedge-shaped connection member into progressively tighter engagement with the wedge-shaped connection member on the cage ring as rotational speed increases.

12. The striking bar of claim 11, wherein the wedge-shaped connection member comprises a wedge-shaped lug projecting from the first end, the second end, or both.

13. The striking bar of claim 11, wherein the wedge-shaped connection member comprises a wedge-shaped recess formed in the first end, the second end, or both, and configured to receive a correspondingly wedge-shaped lug from the cage ring.

14. The striking bar of claim 11, wherein a cross-section of at least a portion of the center section, including the striking face, is wedge-shaped.

15. The striking bar of claim 14, wherein an angle formed between the striking face and at least one of a top surface or a bottom surface of the striking bar is greater than or equal to 80°.

16. A cage ring for a cage mill assembly, the cage ring comprising:
a surface;
a wedge-shaped connection member provided on the surface and configured to engage a correspondingly-shaped wedge-shaped connection member on a striking bar,
wherein the wedge-shaped connection member has a radially inward end having a first width and a radially outward end having a second width, wherein the second width is smaller than the first width,
wherein the wedge-shaped connection member is configured such that, during rotation of the cage ring, centrifugal force acting on the striking bar urges the striking bar radially outward and thereby drives the wedge-shaped connection member on the cage ring and the wedge-shaped connection member on the striking bar into progressively tighter engagement with one another as rotational speed increases, thereby mechanically locking the striking bar to the cage ring with a locking force that increases with rotational speed.

17. The cage ring of claim 16, wherein the wedge-shaped connection member comprises a wedge-shaped recess formed in the surface.

18. The cage ring of claim 16, wherein the wedge-shaped connection member comprises a wedge-shaped lug projecting from the surface.

19. The cage ring of claim 17, wherein the wedge-shaped recess comprises:
a wedge-shaped center section configured to receive a corresponding wedge-shaped portion of the striking bar; and
secondary machined surfaces located on opposite sides of the wedge-shaped center section, wherein the secondary machined surfaces are configured to prevent entry of material into the wedge-shaped recess during operation.

20. The cage ring of claim 16, wherein there is substantially zero clearance between the wedge-shaped connection member on the cage ring and the wedge-shaped connection member on the striking bar when the striking bar is mounted to the cage ring.
